(19) United States
(12) Patent Application Publication
(10) Pub. No.: US 2004/0075878 A1
(43) Pub. Date: Apr. 22, 2004

(54) Method of producing a computer generated hologram

(76) Inventors: Colin D.. Cameron, Worcestershire (GB); Barry McDonald, Worcestershire (GB)

Correspondence Address: NIXON & VANDERHYE, PC, 1100 N GLEBE ROAD, 8TH FLOOR, ARLINGTON, VA, 22201-4714, US

(21) Appl. No.: 10/415,960

(22) PCT Filed: Nov. 5, 2001
(86) PCT No.: PCT/GB01/04885

(30) Foreign Application Priority Data
Nov. 7, 2000 (GB) 0027133.8

(51) Int. Cl. G02B 5/32

(52) U.S. Cl. 359/15

(57) ABSTRACT

An improved methof of producing an interference based computer generated hologram (CGH), where the angle dependent and angle independent components of light emanating from point sources of light on a virtual 3D object are calculated separately. This allows the angle independent components to be calculated only once per point source of light, but enables the angle dependent components to be calculated on a each point source of light to each CGH pixel basis. This method reduces the number of calculations required to produce a CGH, thus reducing computational load, but fully retains the image quality of the 3D image.

This invention relates to an improved method of producing an interference based Computer Generated Hologram (CGH).

A person skilled in the art would be aware of the various approaches that can be used to give a visual perception of 3D. Examples include stereo, auto-stereo, swept volume, integral photography, stereograms and holography. Only holography allows the generation of a real, 3D image which is accessible to all users and has all psychological and physiological cues present.

Classical interferometric holography is well known to those skilled in the art. Light scattered from an object interferes with a reference beam and forms an intensity pattern which can be recorded, for example, on photographic film. To reconstruct an image, the recorded interference pattern modulates a conjugate reference beam of light so that a replica of the original wavefront is reproduced. This wavefront further propagates in space and gives the viewer, or viewers, the full impression that the object really exists in space.

Unlike classical holograms, in a computer generated hologram (CGH) the object used to form the hologram need only exist as a mathematical description. The physical interference of light is replaced by a calculation to determine the appropriate interference pattern on the CGH design plane (CDP) for the given object. Once calculated, the interference pattern may be written to a device capable of light wave modulation. If an updateable 3D image is required the calculated pattern can be written to a reconfigurable device, such as a spatial light modulator (SLM. As with conventional holograms, the 3D image is produced from the modulation of an incident beam of light.

Several techniques of calculating the interference pattern of a virtual object are known to those skilled in the art. For example, Fourier based “ping-pong” methods (Ichioka et. al., Applied Optics 10, 403-11, 1971) and coherent ray tracing techniques (M. Lucente, Jrnl of electronic imaging 2 (1), 28-34 , January 1993).

Although the ping-pong method is simple to implement, it is limited to generating images of self-luminous objects without full rendering and lighting effects. Coherent ray tracing (CRT) techniques, which essentially implement a 3D scalar diffraction integral, simulate closely the propagation of light in a conventional interferometric hologram recording and allow 3D images to be produced which possess realistic lighting effects and surface reflection properties.

For the purpose of CRT calculations, each object point is treated as a point source of light, and the core of the calculation is a linear summation of the E-field contribution from each point source on the virtual 3D object to a single given pixel of the CDP. The summation must then be repeated for each CDP pixel. For convenience, the scalar amplitude contribution of each object point can be partitioned into three components, the ambient, diffuse and specular amplitudes Each of these components are calculated separately.

If the virtual 3D object is illuminated by a plurality of virtual light sources, light will be considered to emanate from each object point in a plurality of directions or, in other words, each object point acts as a plurality of point sources of light. To calculate the total scalar amplitude of light contributed by an object point to a pixel of the CDP, requires the calculation of the amplitude contribution of each point source that is associated with that object point. It can thus be seen that a plurality of amplitude calculations per object point to CDP pixel calculation is necessary to produce a CGH that provides a 3D image with realistic reflection and lighting effects.

It is an object of the present invention to reduce the number of calculations, and hence computational load, associated with the production of an interference based CGH that, when reconstructed, produces a 3D image with realistic lighting and surface reflection properties.

According to this invention, a method for producing an interference based computer generated hologram (CGH) comprises;

i) defining a number of object points, each of which comprises one or more point sources of light; and

ii) defining a plurality of CGH pixels in a CGH design plane; and

iii) determining the total amplitude of light at each CGH pixel contributed by all non-occluded object points; and

iv) determining the optical path-length between each CGH pixel and each non-occluded object point; and

v) calculating the total electric field at each CGH pixel from the amplitude occlusion and optical path-length information; and

vi) determining a CGH interference pattern from the total electric field calculated for each CGH pixel,

wherein, the step of determining the total amplitude of light at each CGH pixel contributed by all non-occluded object points comprises separating the contribution by each point source of light into an angle dependent contribution and an angle independent contribution, calculating the angle independent contribution once for each point source of light and calculating the angle dependent contribution of each point source of light to each CGH pixel.

Herein, the term “angle dependent” is taken to mean that the amount of light contributed by an object point is dependent on the CGH design plane pixel from which that object point is viewed. Conversely, the term “angle independent” is taken to mean that the amount of light contributed by an object point is substantially independent of the CGH design plane pixel from which that object point is viewed.

Preferably, each object point may comprises one point source of light or, depending on the number of light sources in the virtual 3D object scene, each object point may comprise two or more point sources of light.

Advantageously, the angle dependent contribution of each point source of light may be taken to comprise a specular component and the angle independent contribution of each point source of light is taken to comprise both diffuse and ambient components.

In a preferred embodiment of this invention, shadowing information determined during the calculation of the angle independent contribution of a point source of light is used as shadowing information for the corresponding calculation of the angle dependent contribution of that point source of light.

The calculation of an interference based CGH may further comprise the step of calculating the effect on light of a lens placed between the three dimensional object and the CGH design plane. This permits Fourier, rather than Fresnel, replay of the 3D image.

According to a second aspect of this invention, a computer program for calculating an interference based CGH incorporates the method for producing an interference based CGH described above.

According to a third aspect of this invention, an apparatus for the production of a 3D image comprises;

a computing means to calculate an interference based CGH for a virtual 3D object;

a coherent light source;

a spatial light modulation means capable of modulating a light wave with the interference based CGH;

the arrangement being such that illumination of the spatial light modulation means by the light source produces a 3D image of the virtual 3D object, wherein the computing means includes a computer program for calculating an interference based CGH which incorporates the method described above.

In a preferred embodiment, the spatial light modulation means comprises a reconfigurable spatial light modulator.

This invention will now be described, by way of non-limiting example, with reference to the accompanying drawings wherein;

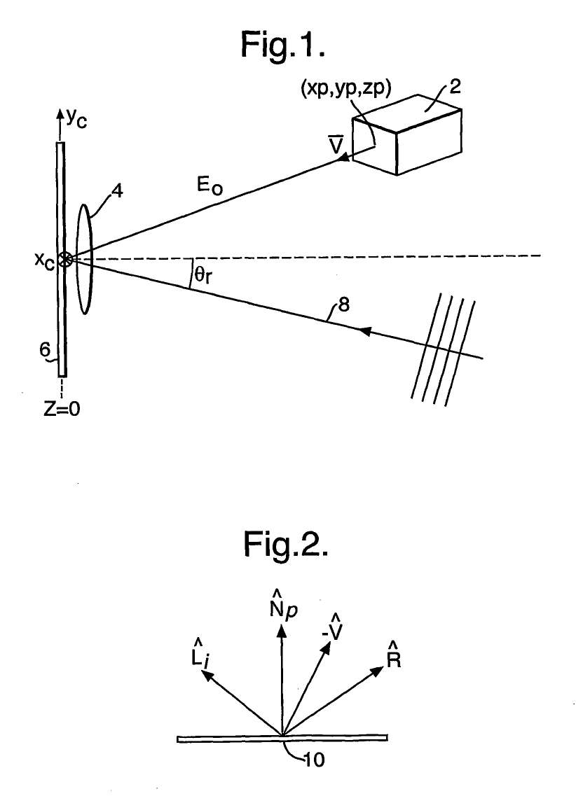

FIG. 1 is a schematic illustration of interference based CGH generation calculations in a Fourier geometry; and

FIG. 2 shows the object point vectors.

Referring to FIG. 1, light from a plurality object points on a virtual three dimensional object (2) passes through a lens (4) and falls on the CGH design plane (6). The virtual 3D object (2), which may be imported from computer aided design packages, is populated with a distribution and density of object points appropriate to attain the required image resolution. The electric field at each CGH design plane pixel can then be calculated by summing the contribution to that pixel from each of the N object points of the 3D object (2).

The electric field at a given CGH pixel is given by:

$${I}_{h} = {\sum }_{p = 1}^{N} {a}_{p} {r}_{p}^{- 1} exp [ ⅈ {Φ}_{p} ] \qquad ( 1 )$$

where αₚ is the amplitude of light i from the p^{th} object point, rₚ is the optical path length from the CDP pixel to the p^{th} object point and φₚ is the phase between the object point and each pixel.

The amplitude term αₚ is given by:

$$\begin{matrix}{a}_{p} = {O}_{e} + GL + {\sum }_{i = 1}^{L} {on}_{i} \times {attenuation}_{i} \times {I}_{i} \times \\ ( {diffuse}_{i} + {ambient}_{i} + {specular}_{i} )\end{matrix} \qquad ( 2 )$$

where Oₑ is a constant emission term, GL is a global ambient light term, L is the number of lights in the scenes onᵢ is a Boolean determining if the light i is incident upon point p, attenuation is the attenuation of the light i, Is Iᵢ is the light intensity, and diffuseᵢ, ambientᵢ, and specularᵢ are the diffuse, ambient and specular components of the object points amplitude.

Referring to FIG. 2, the diffuse, ambient, and specular terms of equation 2 are dependent upon the four vectors V, L, R and N The view vector, V, is the vector from the CGH pixel to object point. The light vector, L, is the vector from the light to the object point (10). The vector R is the direction of the peak specular reflection and the vector Nₚ is the object point's normal vector.

The diffuse, ambient and specular terms can now be described in terms of the four vectors as:

ambientᵢ=Iᵢₐ×O_{d} (3)

diffuseᵢ=Iᵢ×O_{d}×(\hat{N}·\hat{L}ᵢ) (4)

specularᵢ=Iᵢ×O_{S}×(−\hat{V}·\hat{R})^{shininess×128} (5)

where the term Iᵢₐ is the ambient light intensity, O_{d} is the objects diffuse amplitude factor, and Oₛ is the specular factor.

Following this invention, the ambient and diffuse terms can be seen to be independent of the view vector V, hence they are also independent of the hologram pixel for which the intensity is being calculated. Thus Equation 2 can be written as,

αₚ=α_{pad}+αₚ (6)

where,

$$\begin{matrix}{a}_{pad} = {O}_{e} + GL + {\sum }_{i = 1}^{L} {on}_{i} \times {attenuation}_{i} \times {I}_{i} \times ( {diffuse}_{i} + {ambient}_{i} ) \\ and , & ( 7 ) \\ {a}_{p s} = {\sum }_{i = 1}^{L} {on}_{i} \times {attenuation}_{i} \times {I}_{i} \times {specular}_{i} & ( 8 )\end{matrix}$$

It can be seen that α_{pad} is evidently independent of the hologram pixel for which the intensity is being calculated and can thus be pre-computed for each object point prior to the amplitude calculation of Equation 8.

Equation 1 can thus be re-written as,

$${I}_{h} = {\sum }_{p = 1}^{N} ( {a}_{pad} + {a}_{p s} ) {r}_{p}^{- 1} exp [ ⅈ {Φ}_{p} ] \qquad ( 9 )$$

During the pre-computation of α_{pad}, the determination of onᵢ involves a ray-trace between the object point and each light I, i.e. the calculation of shadowing information. This shadowing information can also be stored and then used in the calculation of αₚₛ. All that is then required to calculate Iₕ is the determination of rₚ, a few multiplications and additions, and the calculation of the specular term in Equation 5.

The ray-tracing calculation involved in the calculation of E_{F} is by far the most computationally expensive process in the calculation. By saving the result for α_{pad} and by saving information on the illumination of the object points great savings are made in computational time. The reduced calculation of E_{F}, Equation 9, only includes ray-tracing from the CGH design plane pixels to the object point when determining if the object point is visible at that pixel point or not.

A holographic interference pattern (e. the CGH) is then calculated by simulating the interference of the electric field produced by the 3D object (2) and a reference beam (8). The CGH contains all the information which is necessary to reconstruct the 3D image.

A typical CGH calculation would use approximately 10⁸ object points/m² to ensure that when the hologram is viewed in replay the observer believes the 3D surface to be solid and continuous. A similar number of CGH design plane pixels would also be used.

The saving in computational load to calculate such CGHs has direct benefits in increasing the speed, and thus reducing the computation cost, with which CGHs may be calculated.

1. A method for producing an interference based computer generated hologram (CGH) comprising the steps of,
i) defining a number of object points, each of which comprises one or more point sources of light; and
ii) defining a plurality of CGH pixels in a CGH design plane; and
iii) determining the total amplitude of light at each CGH pixel contributed by all non-occluded object points; and
iv) determining the optical path-length between each CGH pixel and each non-occluded object point; and
v) calculating the total electric field at each CGH pixel from the amplitude, occlusion and optical path-length information; and
vi) determining a CGH interference pattern from the total electric field calculated for each CGH pixel,
wherein, the step of determining the total amplitude of light at each CGH pixel contributed by all non-occluded object points comprises separating the contribution of each point source of light into an angle dependent contribution and an angle independent contribution, calculating the angle independent contribution once for each point source of light and calculating the angle dependent contribution of each point source of light to each CGH pixel.

2. A method for producing an interference based computer generated hologram (CGH) as claimed in claim 1, wherein each object point comprises one point source of light.

3. A method for producing an interference based computer generated hologram (CGH) as claimed in claim 1, wherein each object point comprises two or more point sources of light.

4 A method for producing an interference based computer generated hologram (CGH) as claimed in any preceding claim, wherein the angle dependent contribution of each point source of light comprises a specular component.

5 A method for producing an interference based computer generated hologram (CGH) as claimed in any preceding claim, wherein the angle independent contribution of each point source of light comprises diffuse and ambient components.

6 A method for producing an interference based computer generated hologram (CGH) as claimed in any preceding claim, wherein shadowing information determined during the calculation of the angle independent contribution of a point source of light is used as shadowing information for the corresponding calculation of the angle dependent contribution of that point source of light.

7. A method for producing an interference based CGH as claimed in any preceding claim and further comprising the step of calculating the effect on light of a lens placed between the three dimensional object and the CGH design plane.

8. A method for producing an interference based CGH as substantially hereinbefore described with reference to the accompanying drawings.

9. A computer program for calculating an interference based CGH incorporating the method for producing an interference based CGH as claimed in any of claims 1-8.

10. An apparatus for the production of a 3D image that comprises;
a computing means to calculate an interference based CGH for a virtual 3D object;
a coherent light source;
a spatial light modulation means capable of modulating a light wave with the interference based CGH;
the arrangement being such that illumination of the spatial light modulation means by the light source produces a 3D image of the virtual 3D object,
wherein the computing means includes a computer program for calculating an interference based CGH as claimed in claim 9.

11. An apparatus for the production of 3D images as claimed in claim 10 wherein the spatial light modulation means comprises a re-configurable spatial light modulator.

12. An apparatus for the production of a 3D image as substantially hereinbefore described with reference to the accompanying drawings.
